(19) United States
(12) Patent Application Publication
(10) Pub. No.: US 2007/0075964 A1
(43) Pub. Date: Apr. 5, 2007

(54) MOBILE POINTING DEVICE

(76) Inventor: George Caraian, San Ramon, CA (US)

Correspondence Address: West & Associates, A PC, Suite 209, 2815 Mitchell Drive, Walnut Creek, CA, 94598, US

(21) Appl. No.: 11/530,861

(22) Filed: Sep. 11, 2006

Related U.S. Application Data
(60) Provisional application No. 60/715,858, filed on Sep. 9, 2005.
(60) Provisional application No. 60/786,504, filed on Mar. 27, 2006.

(51) Int. Cl. G09G 5/00

(52) U.S. Cl. 345/156

(57) ABSTRACT

A mobile pointing device having an inverted U-shape such that the device can be supported upon the proximal portion of the index finger of a user. The device can have controls and a wireless connection such that a user can selectively send indicator and/or position signals to an external device. In some embodiments the device can include an image display region on one surface of the device.

### CLAIM OF PRIORITY

This application claims the benefit of U.S. Provisional Application No. 60/715,858, filed Sep. 9, 2005 and United States Provisional Application No. 60/786,504, filed Mar. 27, 2006, the complete contents of each of which is hereby incorporated herein by reference.

### BACKGROUND

1. Field of the Invention

The present invention relates to computer pointing devices and, more particularly, to a hand-held pointing device.

2. Discussion of the Related Art

Computer systems have now invaded virtually every area of human endeavor, most being equipped with a Graphic User Interface (GUI). A GUI assumes that the user thereof is equipped with what is generically referred to as a pointing device. Pointing devices are used to move a cursor around on a computer screen. In addition to providing cursor movement, pointing devices are typically equipped with one or more switches, buttons or similar devices to allow “clicking” on a selected spot on the computer screen. The earliest and probably still the most widely used pointing device is the ubiquitous “mouse”, A mouse typically has a contoured housing having a flat bottom surface equipped with a ball which moves on a flat surface. A mechanism inside the mouse generates signals corresponding to the movement of the mouse in both the X and Y directions on the flat surface. It has been suggested, however, that the extended use of a mouse may lead to or aggravate carpel tunnel syndrome.

Another widely used class of pointing devices is called a trackball device. In operation, a trackball may be envisioned as an inverted mouse where the ball resides on the top surface of the device rather than on the bottom surface. A user directly manipulates the ball to generate X and Y signals similar to those generated by a mouse. Track ball devices typically require less movement than do mice and, because they do not rely on a flat surface for operation, may be placed in possibly more convenient locations relative to their users. Trackballs still require that users keep an arm and hand in a relatively fixed position while using the device.

It would appear desirable to provide a pointing device which did not require that a user maintain a constant, fixed physical relationship to the fixed surface upon which the pointing device is manipulated. The pointing device of the present invention allows the user greater flexibility in positioning himself or herself relative to the computer screen.

U.S. Pat. No. 5,296,871, for THREE-DIMENSIONAL MOUSE WITH TACTILE FEEDBACK, issued Mar. 22, 1994 to W. Bradford Paley, teaches one implementation of a hand-held pointing device. PALEY teaches the use of deformable means acting as sensors to generate signals representatives of movement along not only in the X and Y axes but in the Z axis as well. There is no teaching of a trackball or similar device.

In contradistinction, the hand-held trackball of the present invention provides a small trackball pointing device packaged in an ergonomically correct housing. There are no deformable means necessary to sense pointing device motions. Rather, the necessary signals are generated by the trackball device itself. In alternate embodiments, a strap is provided to keep the inventive trackball device affixed to a user's hand while allowing use of the fingers and/or hand for other activities without need to set the pointing device down.

U.S. Pat. No. 5,512,892, for HAND HELD CONTROL DEVICE, issued Apr. 30, 1996 to Liam P. Corballis, et al., teaches a controller having a number of switch type actuators. A pointing stick is also included but no trackball is present.

U.S. Pat. No. 5,724,106, for HAND HELD REMOTE CONTROL DEVICE WITH TRIGGER BUTTON, issued Mar. 3,1998 to Sidney David Autry, et al., discloses a flat remote control device in a similar form factor to a “TV” remote control. A trackball is located in a central region of the upper surface of the device. There is no teaching of a package having an ergonomically correct shape to be grasped and operated in a single hand of a user. Neither is there any provision for a band or other attachment means for securing the trackball unit to a user's hand.

U.S. Pat. No. 6,184,862, for APPARATUS FOR AUDIO DICTATION AND NAVIGATION OF ELECTRONIC IMAGES AND DOCUMENT, issued Feb. 6, 2001, to Thomas Leiper discloses a hand-gripped remote control. The primary function of the LEIPER apparatus is to scan through a series of MRI or similar diagnostic images while dictating notes regarding the images.

What is needed is a wireless hand-held pointing device that can be utilized in multiple ways and incorporates a display area.

What is also needed is a hand-held pointing device which fits comfortably in a user's hand and a hand-held pointing device which is symmetrical and may be used comfortably by either a left-handed or a right-handed person.

Additionally, what is needed is a hand-held pointing device which incorporates two or more button switches corresponding to the buttons found on a classic mouse-type pointing device.

### BRIEF DESCRIPTION OF THE DRAWINGS

FIG. 1 depicts a perspective front view of one embodiment of a hand-held pointing device.

FIG. 2 depicts a perspective rear view of the embodiment shown in FIG. 1.

FIG. 3 depicts a rear view of an alternate embodiment of the hand-held pointing device shown in FIGS. 1 and 2.

FIG. 4 depicts an image of the hand-held pointing device shown in FIGS. 1 and 2, in use.

FIG. 5 depicts an image of the hand-held pointing device shown in FIGS. 1 and 2, in use.

FIG. 6 depicts an alternate embodiment of the hand-held pointing device shown in FIGS. 1 and 2.

FIG. 7 depicts an alternate embodiment of the hand-held pointing device shown in FIGS. 1 and 2

FIG. 8 depicts an underside view of some embodiments of the hand-held pointing device shown in FIGS. 1-7.

### DETAILED DESCRIPTION

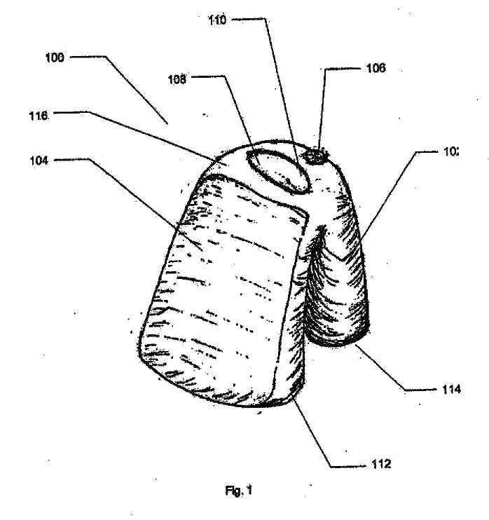

FIG. 1 depicts a perspective front view of one embodiment of a hand-held pointing device 100. In the embodiment shown in FIG. 1, the hand-held pointing device comprises a rear handle 102 and front panel 104 that coupled together in an arched pattern. Additionally, the hand-held pointing device 100 shown in FIG. 1 comprises a position/direction indicator mechanism 106 and selection buttons 108 110. The hand-held pointing device 100 also comprises an antenna capable transmitting and receiving a signal.

In the embodiment shown in FIG. 1, the rear handle 102 and the front panel 104 are coupled together via an arched connection such that the connection allows the device 100 to be supported over the index finger of the hand of a user. Additionally, in the embodiment shown in FIG. 1, the rear handle 102 and front panel 104 are configured such that a user's hand can close at least partially around the rear handle 102. In alternate embodiments, the rear handle 102 and the front panel can be coupled together in any other known and/or convenient manner and/or geometric relation.

In some embodiments, the front panel 104 can include any desired image or surface mounted and/or embedded image.

In the embodiment shown in FIG. 1, the rear handle 102 and the front panel 104 each have bottom surfaces 112 114 and the rear handle 102 and the front panel 104 are configured such that the bottom surfaces 112 114 of the device 100 can rest on any substantially flat surface in an upright position.

In the embodiment shown in FIG. 1, the position/direction indicator 106 is a joy stick and is positioned on the device 100 such that it can be conveniently operated by the thumb of a user. Additionally, the selection buttons 108 110 are positioned on the device 100 such that they can be conveniently operated by the thumb of a user. While the position/direction indicator 106 and the selection buttons 108 110 are depicted in a specific geometry in the embodiment shown in FIG. 1, in alternate embodiments they can be positioned having any known and/or convenient geometric relationship. Moreover, in some embodiments the number of selection buttons can be any convenient number. In alternate embodiments, the position/direction indicator 106 can be a touchpad mechanism, an optical motion detection mechanism, an optical mechanism, a track-ball mechanism and/or any other known and/or convenient method and/or mechanism.

In the embodiment shown in FIG. 1, the device 100 includes an antenna 116. In some embodiments the antenna can be capable of sending and/or transmitting a signal. The signal can be any know and/or convenient form, can contain any convenient information and can be transmitted using any known and/or convenient method and/or mechanism. In some embodiments, the signal can include data regarding manual input received from the position/direction indicator 106 and/or the selection buttons 108 110.

In some embodiments, the device can be powered by an internal power supply, such as a standard and/or rechargeable battery. However, in alternate embodiments, the device can be physically connected to a power source and/or a signal receiving device.

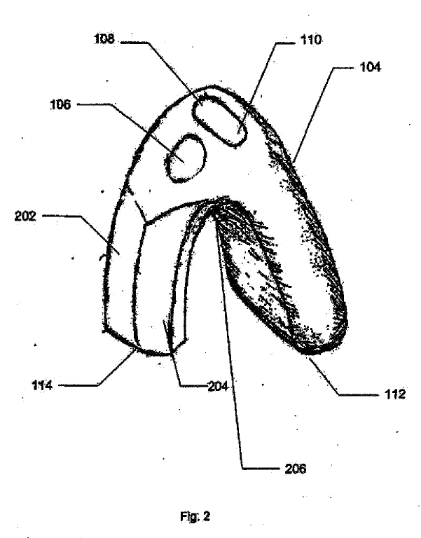

FIG. 2 depicts a perspective rear view of the embodiment shown in FIG. 1. In the embodiment shown in FIG. 2, the device 100 includes two handle buttons 202 204.

In the embodiment shown in FIG. 2, the handle buttons 202 204 run from the base of the rear handle 102 to the top of the rear handle 102 and are single buttons. However, in alternate embodiments the handle buttons 202 204 can be intermittent along the rear handle 102. In some embodiments, the device 100 can include any convenient number of handle buttons 202 204 located in any convenient locations along the rear handle 102.

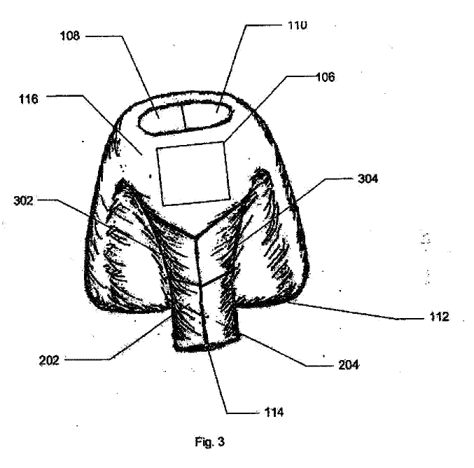

FIG. 3 depicts a rear view of an alternate embodiment of the hand-held pointing device shown in FIGS. 1 and 2. In the embodiment shown in FIG. 3, the position/direction indicator 106 is an optical finger sensor and the rear handle 102 includes four buttons 202 204 302 304.

According to one embodiment the control device 100 with no moving parts is provided for generating control signals for such applications as controlling movement of a pointer on a display, or, more generally, for controlling the various functions of an apparatus. The control device 100 employs an optically transmissive platen upon which the user places a fingertip. From the opposite side of the platen, a light-emitting diode emits light through the platen which is diffused by the user's fingertip. A photodetector is disposed in such a manner as to only receive light diffused and/or reflected beyond the critical angle of the platen material. That is, the photodetector receives an image of an object, e.g., the fingertip, in contact with the platen and none of the ambient light because it cannot travel beyond the critical angle of the platen. According to some embodiments, a lens or system of lenses focuses the light from the fingertip onto the photodetector.

According to a specific embodiment of the device 100, the photodetector is configured into quadrants, each of which receives a portion of the light corresponding to the fingertip image and generates charge in proportion to the amount received. That is, the light energy received in each quadrant and the resultant charge generation are a function of the contact area of the fingertip in the corresponding platen quadrant. Any slight motion of the fingertip on the platen affects the size, shape and location of the fingertip's contact area which is, in turn, tracked in substantially real time by corresponding changes in the charge generation in the photodetector quadrants. The charge generation and the changes therein caused by movement of the fingertip on the platen are then converted to a control signal which may be used, for example, to control movement of a pointer on a display screen. Because, in such an embodiment, each of the photodetectors quadrants corresponds to a particular pointer direction, the control signal combines information from the charge generated in each quadrant to determine the direction and speed of the pointer on the screen.

Therefore, by optically sensing minute movements of the user's fingertip on the platen using optical components, a control signal for the display pointer is generated without the use of mechanical components. Moreover, because inexpensive four quadrant photodetectors are commercially available, and because the other device components are inexpensive, the pointing device of the present invention may be manufactured at a very low unit cost.

According to another embodiment, a dual-mode control device is provided which employs a configurable matrix array as the detector. In one mode, the matrix array is biased so that it is divided into a plurality of multi-pixel sectors, each of which acts as a single photosensitive region from which stored charge can be downloaded in a single step. In this mode, the device acts like the control device described above. In the second mode, the matrix array is biased to act like a high resolution imaging device to capture a detailed image of the user's fingerprint.

Thus, according to one embodiment of the device includes an apparatus for generating a control signal which corresponds to movement of an object in contact with a platen are described. The platen has a first surface and is characterized by a critical angle beyond which light incident upon the first surface is not transmitted. A source of electromagnetic radiation emits electromagnetic radiation through the platen which is diffused by the object. A detector having a plurality of sectors receives a portion of the electromagnetic radiation diffused by the object and transmitted through the platen beyond the critical angle. The sectors of the detector accumulate charge in response to the incident electromagnetic radiation. Conversion circuitry then converts the charge accumulated in the detector to the control signal.

According to some embodiments, the object comprises a fingertip and the control signal is for controlling movement of a pointer on a display in response to the movement of the fingertip on the platen. In this embodiment, the charge is converted to a digital serial signal compatible with a computer serial data port, e.g., a mouse port. In a more specific embodiment, a selection signal may be generated for selecting an item on the display indicated by the pointer.

The selection signal is generated in response to a sequence of intermittent contacts between the fingertip and the platen.

According to another specific embodiment, the control signal is initialized for the initial position of the fingertip on the platen such that movement of the pointer does not occur when the fingertip is in the initial position. The control signal is reinitialized in this way each time the fingertip is removed from the platen and replaced thereon.

According to another embodiment, the control signal is generated by a television remote control device and may be used to control a variety of television functions such as, for example, volume and channel selection. In one embodiment, each of the sectors of the detector corresponds to a television remote control function with opposite sectors controlling opposing functions. For example, in a four sector embodiment, the right and left sectors may represent channel up and down, respectively, while the up and down sectors may represent volume up and down, respectively. The charge generation distribution in the detector indicates the selected function, the control signal for which is then transmitted to the television.

The above-described specific embodiments of the position/direction indicator 106 and/or the buttons 108 110 202 204 302 304 can each be implemented using either “dark field” or “bright field” configurations A “dark field” configuration refers to a configuration in which the detector receives no light unless an object, e.g., a fingertip, is in contact with the platen. This is accomplished by orienting the radiation source and the detector in such a way that only light diffused by the object in contact with the surface impinges upon the detector.

Conversely, a “bright field” configuration refers to a configuration in which the detector is illuminated whenever the radiation source is on because the radiation source is oriented such that it illuminates the platen from beyond the critical angle and is totally reflected in the direction of the detector unless an object is in contact with the platen. When an object is in contact with the platen, the light impinging on the area of contact is diffused and the energy reaching the detector is correspondingly reduced. That is, the area of contact “appears” darker to the detector than the surrounding area of the platen. With either implementation, substantially the same information may be derived from charge generated by the detector through the use of appropriate signal polarity conversions.

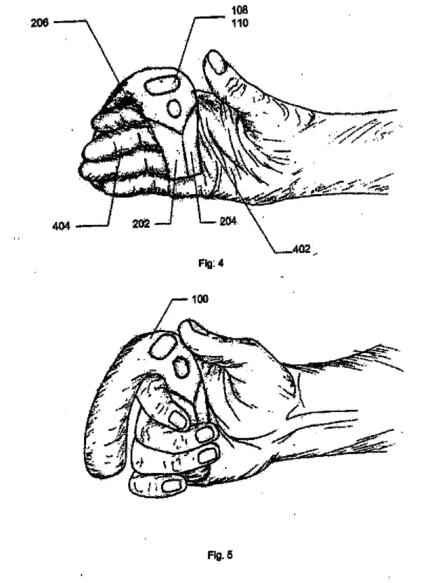

FIGS. 4 and 5 depict images of the hand-held pointing device shown in FIGS. 1 and 2, in use. In FIG. 4, the device 100 is supported on the proximal portion of the index finger of a user's open hand. From this position, the user can operate the controls (buttons 108 110 202 204 302 304 and/or position/direction indicator 106) with the thumb on the hand supporting the device 100 and/or with the user's opposite hand. The relaxed and natural position of the user's hand assists in elimination of fatigue and/or strain that is associated with the operation of a standard mouse.

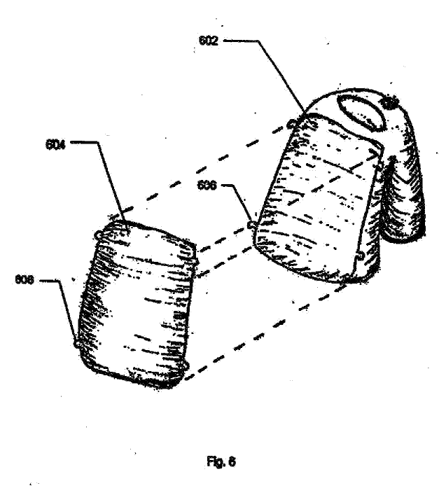

FIG. 5 depicts how a user can operate the handle buttons 202 204 302 304 using either a portion of the palm 402 of the hand or the fingers 404. FIG. 6 depicts an alternate embodiment of the hand-held pointing device shown in FIGS. 1 and 2. In the embodiment shown in FIG. 6, the device 100 includes an image panel 602, an cover 604 and an engagement mechanism 606 608 adapted to selectively couple the image panel 602 and the cover 604.

On the embodiment shown in FIG. 6, the front panel 112 includes a image panel 602. In some embodiments the image panel 602 can be recessed into the front panel 112 and/or may be substantially flush with the front panel 112. The image panel 602 is adapted to receive an image of a user's selection. In some embodiments, the image can be a photograph, a sticker and/or any other known and/or convenient image.

In the embodiment shown in FIG. 6, the front panel 112 and/or image panel 602 is adapted to selectively couple with the cover 604. In some embodiments the cover 604 can be comprised of a plastic, glass and/or any other known and/or convenient transparent material.

In the embodiment shown in FIG. 6, the front panel 112 and the cover 604 are depicted as being selectively coupleable via a snap-fit mechanism. However, in alternate embodiments any known and/or convenient mechanism can be used to selectively couple the cover 604 with the front panel 112 and/or the image panel 602. In still further alternate embodiments, the device 100 may not include a cover 604 and/or and engagement mechanism 606 608.

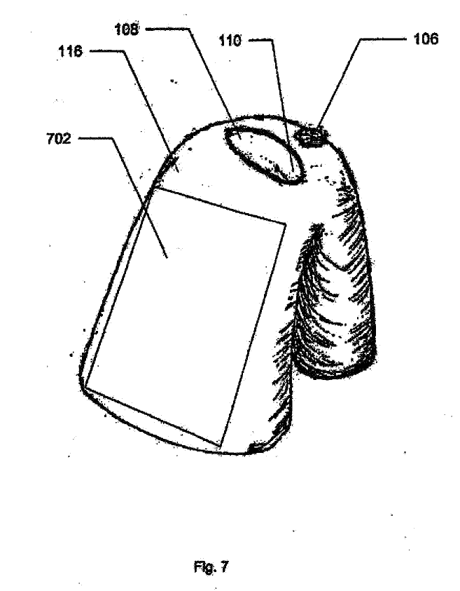

FIG. 7 depicts an alternate embodiment of the hand-held pointing device shown in FIGS. 1 and 2. In the embodiment shown in FIG. 7, the front panel 112 includes an LCD display 702. In the embodiment shown in FIG. 7, the LCD display 702 can display any user selected image, images and/or video. In some embodiments, the images and/or video can be transmitted to the device 100 wirelessly via the antenna 116. However, in alternate embodiments the device 100 can receive images and/or video in any known and/or convenient manner. Moreover, in still further alternate embodiments the LCD display 702 can be any known and/or convenient type of display that can be conveniently coupled with the device 100.

FIG. 8 depicts an underside view of some embodiments of the hand-held pointing device shown in FIGS. 1-7. In the embodiment shown in FIG. 8, the device 100 includes a second position/direction indicator 802. In some embodiments, the position indicator can be a ball mechanism. However, in alternate embodiments the position/direction indicator 802 can be an optical sensor assembly and/or any other known and/or convenient position/direction indication apparatus and/or mechanism.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

1. A mobile pointing device comprising:
a front panel having a display surface;
a rear handle;
a u-shaped coupling element coupling said front panel and said rear handle;
a position-direction indicator device associated with said u-shaped coupling element;
at least one selector button associated with said u-shaped coupling element;
at least one handle selector button associated with aid rear handle; and
an element capable of transmitting a signal associated with a signal received from at least one of said position-direction indicator, said at least one selector button and said at least one selector handle.

2. The device of claim 1 further comprising:
a cover selectively couplable with said front panel.

3. The device of claim 2 wherein said cover is at least partially transparent.

4. The device of claim 1 further comprising:
an display panel associated with said display surface.

5. The device of claim 4 wherein said display panel is an LCD display.

6. The device of claim 4 wherein said display panel is a plasma display.

7. The device of claim 3 wherein said display surface include a recess for adapted to receive a user selectable image.

8. The device of claim 7 wherein said position-indicator device is an optical position-indicator device.

9. The device of claim 8 further comprising:
a second position-indicator device associated with a bottom surface of said front panel.

10. The device of claim 9 wherein said second position-indicator device is a ball mechanism.

11. The device of claim 9 wherein said second position-indicator device is an optical mechanism.

12. The device of claim 4 wherein said display surface include a recess for adapted to receive a user selectable image.

13. The device of claim 12 wherein said position-indicator device is an optical position-indicator device.

14. The device of claim 13 further comprising:
a second position-indicator device associated with a bottom surface of said front panel.

15. The device of claim 14 wherein said second position-indicator device is a ball mechanism.

16. The device of claim 14 wherein said second position-indicator device is an optical mechanism.
